(19) United States
(12) Patent Application Publication
(10) Pub. No.: US 2015/0124494 A1
(43) Pub. Date: May 7, 2015

(54) ADAPTIVE SYNCHRONOUS RECTIFIER CONTROL

(71) Applicant: iWatt Inc., Campbell, CA (US)

(72) Inventor: Andrey B. Malinin, Fort Collins, CO (US)

(73) Assignee: iWatt Inc., Campbell, CA (US)

(21) Appl. No.: 14/070,036

(22) Filed: Nov. 1, 2013

(51) Int. Cl. H02M 3/335

(52) U.S. Cl. CPC H02M 3/33592
USPC 363/21.14

(57) ABSTRACT

The embodiments herein describe a switched mode power converter. In particular, the embodiments herein disclose techniques for adaptive synchronous rectification control. The switched mode power supply includes a synchronous rectifier controller that determines when to turn off the synchronous rectifier during each switching cycle based on a reference signal corresponding to when substantially all the power stored in a transformer of the power supply has been delivered to an electronic load. The synchronous rectifier controller may determine whether to adjust the reference signal used by the synchronous rectifier controller to turn off the synchronous rectifier during subsequent switching cycles.

### BACKGROUND

1. Field of Technology

Embodiments disclosed herein relate generally to switching power converters, and more specifically, to techniques for adaptive synchronous rectification control.

2. Description of the Related Arts

FIG. 1 is a circuit diagram of a conventional flyback type switching power converter 100 that uses a switch Q1 such as a metal-oxide-semiconductor field-effect transistor (MOSFET). The switching power converter 100 includes a power stage 101 and a secondary output stage 103. Power stage 101 includes the switch Q1 and a power transformer T1. Power transformer T1 includes primary winding Np, secondary winding Ns, and auxiliary winding Na. Secondary output stage 103 includes diode D₁ and output capacitor C₁. A controller 105 controls the ON state and the OFF state of switch Q1 using output drive signal 107 in the form of a pulse with on-times (T_{ON}) and off-times (T_{OFF}).

AC power is received from an AC power source (not shown) and is rectified to provide the unregulated input voltage V_{DC}. The input power is stored in transformer T1 while the switch Q1 is turned on, because the diode D₁ becomes reverse biased when the switch Q1 is turned on. The rectified input power is then transferred to an electronic device across the capacitor C₁ while the switch Q1 is turned off, because the diode D₁ becomes forward biased when the switch Q1 is turned off. Diode D₁ functions as an output rectifier and capacitor C₁ functions as an output filter. The resulting regulated output voltage V_{OUT} is delivered to the electronic device.

In high output current applications, the conduction loss of the diode D₁ operating as the output rectifier is significant. A MOSFET or other actively-controlled switch may replace the diode D₁ to minimize conduction loss in the power converter 100 during high output current applications. The MOSFET functions as a synchronous rectifier in the power converter 100. To achieve proper operation of the synchronous rectifier, a synchronous rectifier controller is added to the power converter 100 to control the operation of the synchronous rectifier.

Because a MOSFET device is bi-directional, the on and off state of the MOSFET must be carefully controlled, essentially mimicking the functional operation of a diode device. When switch Q1 is placed in the on state, primary current Iₚᵣᵢ flows through the primary winding Np of the transformer T1. The synchronous rectifier MOSFET must be placed in the off state by the synchronous rectifier controller when switch Q1 is on. However, conventional synchronous rectifier controllers cannot reliably detect the optimum point at which to place the synchronous rectifier MOSFET from the on state to the off state. This results in variation of operational performance of synchronous rectification systems including increased power loss due to excessive body diode conduction or reverse current to occur.

### SUMMARY

The embodiments herein disclose a method for adaptive synchronous rectification control of a synchronous rectifier in a switched mode power supply. In one embodiment, the switched mode power supply includes a synchronous rectifier controller that determines when to turn off the synchronous rectifier during each switching cycle based on a reference signal corresponding to when substantially all the energy stored in a transformer of the power supply has been delivered to an electronic load. The synchronous rectifier controller may adjust the length of time that the synchronous rectifier switch is turned on during subsequent switching cycles based on whether the synchronous rectifier switch was turned off before substantially all the energy stored in the transformer is delivered to the electronic load during a given switching cycle or based on whether the synchronous rectifier switch was turned off after a threshold amount of time from when all the energy stored in the transformer is delivered to the electronic load during the switching cycle.

The features and advantages described in the specification are not all inclusive and, in particular, many additional features and advantages will be apparent to one of ordinary skill in the art in view of the drawings and specification. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the embodiments of the present disclosure can be readily understood by considering the following detailed description in conjunction with the accompanying drawings.

FIG. 1 is a circuit diagram of a conventional switching power converter.

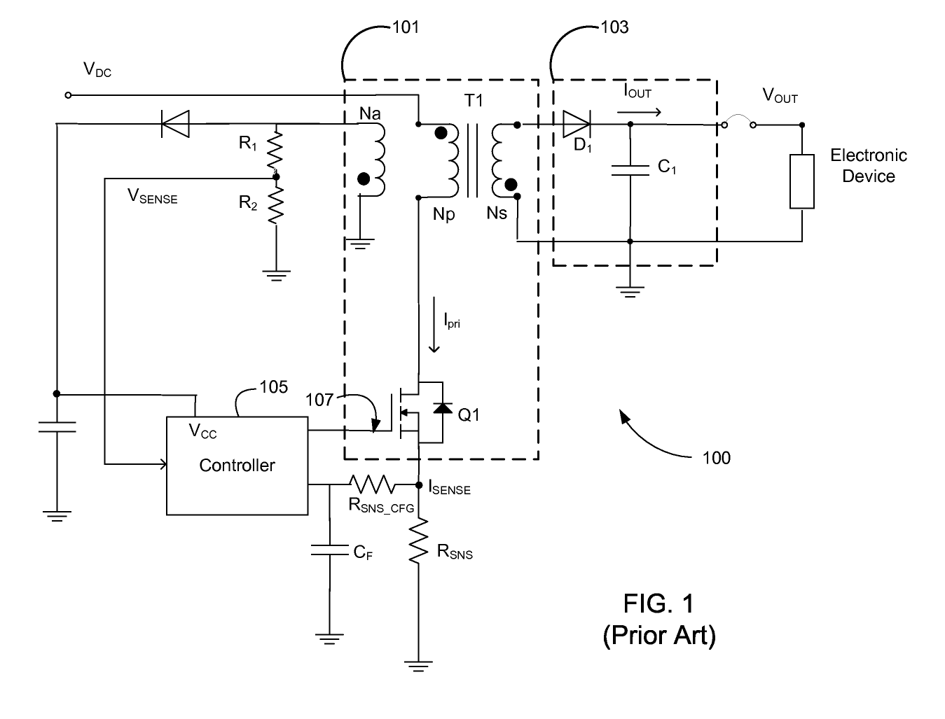

FIG. 2 is a circuit diagram of a switching power converter including a synchronous rectifier circuit according to one embodiment.

FIG. 3 is a method flow diagram of a synchronous rectifier controller according to one embodiment.

FIG. 4 is a circuit diagram illustrating a detailed view of the synchronous rectifier circuit of FIG. 2 according to one embodiment.

FIG. 5 is a circuit diagram of a reference generator according to one embodiment.

FIG. 6 illustrates waveform diagrams of the switching power converter.

### DETAILED DESCRIPTION OF EMBODIMENTS

The Figures (FIG.) and the following description relate to various embodiments by way of illustration only. It should be noted that from the following discussion, alternative embodiments of the structures and methods disclosed herein will be readily recognized as viable alternatives that may be employed without departing from the principles discussed herein.

Reference will now be made in detail to several embodiments, examples of which are illustrated in the accompanying figures. It is noted that wherever practicable similar or like reference numbers may be used in the figures and may indicate similar or like functionality. The figures depict various embodiments for purposes of illustration only. One skilled in the art will readily recognize from the following description that alternative embodiments of the structures and methods illustrated herein may be employed without departing from the principles described herein.

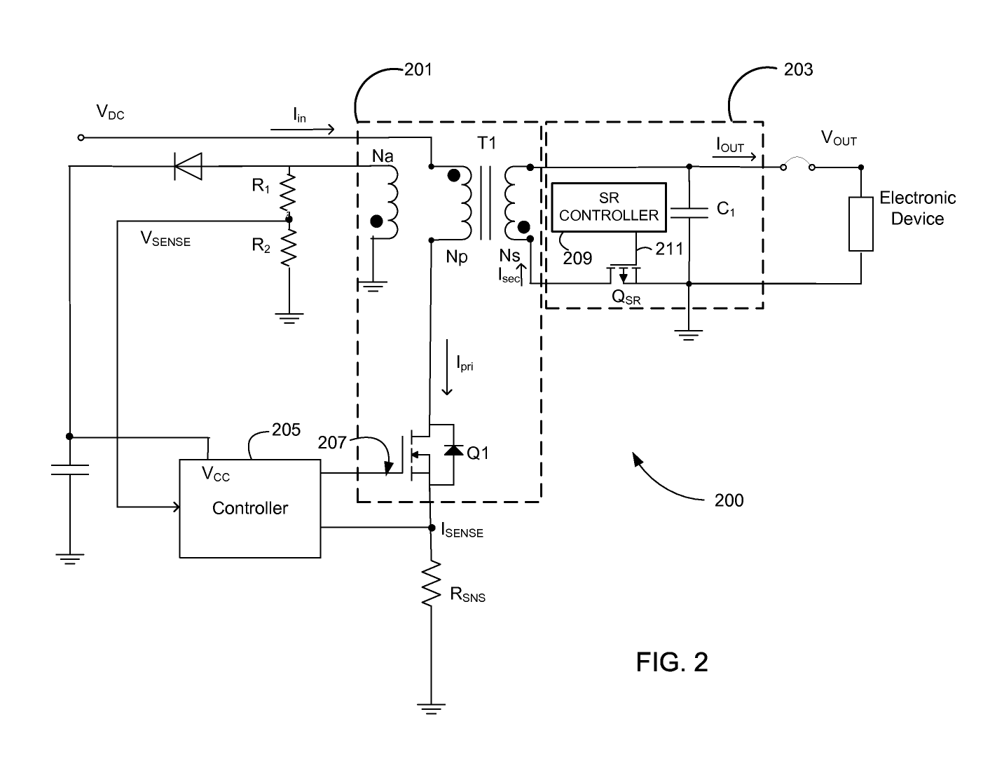

FIG. 2 is a circuit diagram of a flyback type switching power converter 200. As shown in FIG. 2, the power converter 200 includes a switch Q1. In one embodiment, the switch Q1 is a MOSFET. However, the switch Q1 may be any type of switching device such as a bipolar junction transistor (BJT). The switching power converter 200 includes a power stage 201 and a secondary output stage 203. Power stage 201 includes the switch Q1 and a power transformer T1. Power transformer T1 includes primary winding Np, secondary winding Ns, and auxiliary winding Na. Secondary output stage 203 includes an output capacitor C₁ and a synchronous rectifier circuit. In one embodiment, the synchronous rectifier circuit includes a synchronous rectifier switch Q_{SR} and a synchronous rectifier (SR) controller 209 as will be further described below. As shown in FIG. 2, the synchronous rectifier circuit is coupled between an lower side of the secondary winding Ns of the transformer T1 and the output ground terminal. A controller 205 controls the on state and the off state of switch Q1 using output drive signal 207 in the form of a pulse with on-times (T_{ON}) and off-times (T_{OFF}). That is, the controller 205 generates the output drive signal 207 that drives the switch Q1.

AC power is received from an AC power source (not shown) and is rectified to provide the unregulated input voltage V_{DC}. When switch Q1 is on, energy is stored in transformer T1 via the primary winding magnetizing inductance. When the switch Q1 is on, the synchronous rectifier switch Q_{SR} is disabled (i.e., off) and it's body diode is reverse biased thereby blocking a current pathway of the transformer secondary winding Ns. When switch Q1 is turned off, energy stored in the magnetizing inductance of the transformer T1 will be transferred to capacitor C1 through the body diode of the synchronous rectifier switch Q_{SR}. When the synchronous rectifier switch Q_{SR} is turned on, the additional pathway with the lower than forward biased diode voltage drop to deliver the stored energy to the capacitor C1 is created. Generally, the synchronous rectifier switch Q_{SR} functions as an output rectifier and capacitor C₁ functions as an output filter. The resulting regulated output voltage V_{OUT} is delivered to the electronic device with less loss than in case without the synchronous rectifier.

As mentioned previously, the controller 205 generates appropriate switch drive pulses 207 to control the on-times and off-times of switch Q1 and regulate the output voltage V_{OUT}. The controller 205 controls switch Q1 using a feedback loop based on the sensed output voltage V_{SENSE} and the sensed primary side current Iₚᵣᵢ in previous switching cycles of the switching power converter 200 to generate the timings to turn on or off the switch Q1 in subsequent switching cycles, in a variety of operation modes including PWM (pulse width modulation) and/or PFM (pulse frequency modulation) modes. I_{SENSE} is the voltage across resistor R_{SNS} and is used by the controller 205 to sense the primary current Iₚᵣᵢ through the primary winding Np and switch Q1 in the form of a voltage across the sense resistor R_{SNS} and ground.

FIG. 2 illustrates primary-side control, where the output voltage V_{OUT} is reflected across auxiliary winding Na of transformer T1, which is input to controller 205 as the voltage V_{SENSE} via a resistive voltage divider comprised of resistors R₁ and R₂. Based on the sensed output voltage, the controller 205 determines the times at which the switch Q1 is turned on in PFM, PWM, or any other regulation mode employed by the controller 205. However, synchronous-rectification control as described herein may also be used in conjunction with secondary-side output voltage sensing.

In one embodiment, the synchronous rectifier switch Q_{SR} is a MOSFET versus the diode D1 in the conventional power converter 100. The synchronous rectifier switch Q_{SR} couples the lower side of the secondary winding Ns of the transformer T1 to the output ground of the converter 200 and operates as a pathway to transfer energy stored in the transformer T1 to the capacitor C1. As shown in FIG. 2, the source terminal of the synchronous rectifier switch Q_{SR} is coupled to the ground terminal of the output of power converter 200. The drain terminal of the synchronous rectifier switch Q_{SR} is coupled to the lowerside of the secondary winding Ns of the power transformer T1. The gate terminal of the synchronous rectifier switch Q_{SR} is coupled to the SR controller 209 included in the synchronous rectifier circuit.

The SR controller 209 controls the on state and off state of the synchronous rectifier switch Q_{SR} using output drive signal 211. Generally, the SR controller 209 generates the output drive signal 211 to turn off the synchronous rectifier switch Q_{SR} when the switch Q1 is on, and to turn on the synchronous rectifier switch Q_{SR} on when switch Q1 is off.

During operation of the power converter 200 in the discontinuous conduction mode (DCM), the optimum time for the SR controller 209 to turn off the synchronous rectifier switch Q_{SR} is when substantially all of the energy stored in the transformer T1 has been delivered to the capacitor C1, which corresponds to the instant when the secondary current I_{sec} reaches 0 amps. In one embodiment, the SR controller 209 determines when to turn off the synchronous rectifier switch Q_{SR} during each switching cycle based on a reference value corresponding to when the secondary current I_{sec} reaches 0 amps. By observing the drain to source voltage of the synchronous rectifier switch Q_{SR} during each switching cycle of the power converter 200, the SR controller 209 makes necessary adjustments to the reference value for subsequent switching cycles thereby adjusting the length of time that the synchronous rectifier switch Q_{SR} is on during the subsequent switching cycles. This allows for operation of the power converter 200 that is not susceptible to variations in device and/or system level variations due to manufacturing and the operating environment.

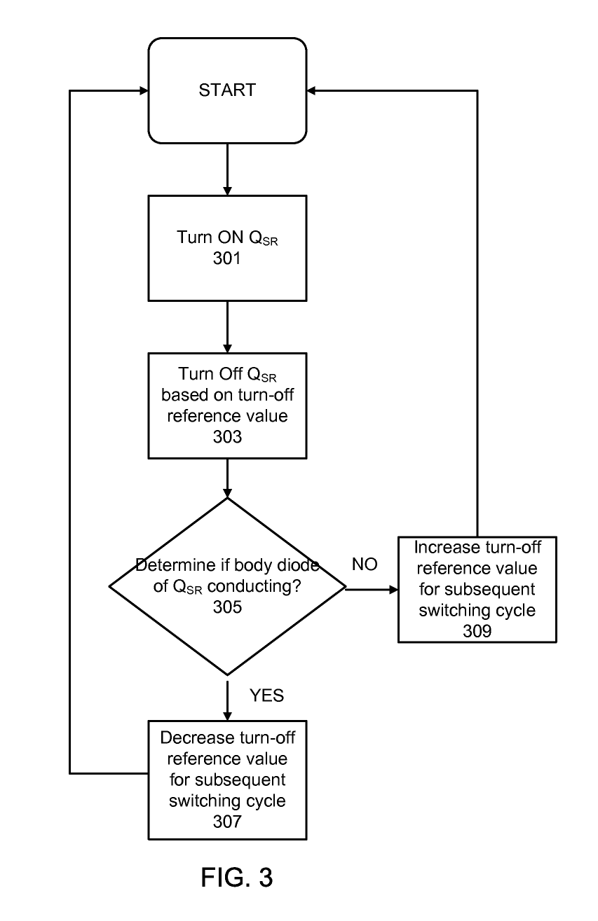

FIG. 3 is a diagram describing how the SR controller 209 adjusts the reference value for turning off the synchronous rectifier switch Q_{SR} according to one embodiment. The SR controller 209 turns on 301 the synchronous rectifier switch Q_{SR} during a switching cycle N. Generally, the SR controller 209 turns on the synchronous rectifier switch Q_{SR} during switching cycle N when switch Q1 is off during switching cycle N. The SR controller 209 turns off 303 the synchronous rectifier switch Q_{SR} during switching cycle N based on a reference value which was set by the SR controller 209 during the previous switching cycle N−1.

The SR controller 209 determines 305 if the body diode of the synchronous rectifier switch Q_{SR} is conducting after the synchronous rectifier switch Q_{SR} is turned off. Whether the body diode is conducting signifies if the SR controller 209 turned off the synchronous rectifier switch Q_{SR} too early or too late as will be further described below. The SR controller 209 determines if the body diode is conducting based on the drain-to-source voltage drop of the synchronous rectifier switch Q_{SR}. For example, a drain-to-source voltage drop of 0.7 V signifies that the body diode is conducting.

If the body diode of the synchronous rectifier switch Q_{SR} is conducting after the synchronous rectifier switch Q_{SR} is turned off, the SR controller 209 lowers 307 the reference value that will be used to turn off the synchronous rectifier switch Q_{SR} during the subsequent switching cycle N+1. By lowering the reference value, the SR controller 209 lengthens the duration in which the synchronous rectifier switch Q_{SR} is on during the switching cycle N+1. Conversely, if the body diode of the synchronous rectifier switch Q_{SR} is not conducting after the synchronous rectifier switch Q_{SR} is turned off, the SR controller 209 increases 309 the reference value that will be used to turn off the synchronous rectifier switch Q_{SR} during the subsequent switching cycle N+1. By raising the reference value, the SR controller 209 shortens the duration in which the synchronous rectifier switch Q_{SR} is on during the switching cycle N+1.

Note that in the embodiment where the synchronous rectifier switch Q_{SR} is coupled between the upper side of the secondary winding Ns and the capacitor C1, the SR controller 209 raises the reference value for the subsequent switching cycle N+1 in order to lengthen the time in which the synchronous rectifier switch Q_{SR} is on during the switching cycle N+1 and the SR controller 209 lowers the reference value for the subsequent switching cycle N+1 in order to shorten the time in which the synchronous rectifier switch Q_{SR} is on during the switching cycle N+1.

After the reference value is adjusted, the SR controller 209 repeats the method shown in FIG. 3 for the subsequent switching cycle N+1 to determine the reference value for switching cycle N+2. Thus, the SR controller 209 “hunts” for the optimal reference value that will be used to turn off the synchronous rectifier switch Q_{SR} during subsequent switching cycles.

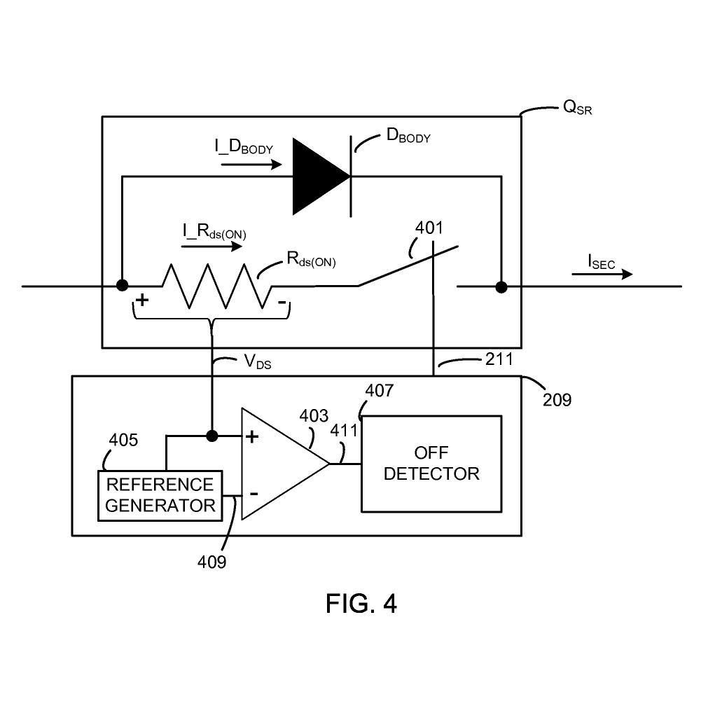

FIG. 4 is a circuit diagram illustrating a detailed view of the synchronous rectifier switch Q_{SR} and the SR controller 209 according to one embodiment. In FIG. 4, an equivalent circuit model is shown of the synchronous rectifier switch Q_{SR}. The synchronous rectifier switch Q_{SR} is represented by an on-time resistor R_{ds(ON}), a switching element 401 coupled to the on-time resistor R_{ds(ON)}, and a body diode D_{BODY}. The on-time resistor R_{ds(ON)} is representative of the resistance of the MOSFET channel when the synchronous rectifier switch Q_{SR} is in the on-state.

In one embodiment, the SR controller 209 includes a comparator 403, a reference generator 405, and an off detector 407. The positive (+) input of the comparator 403 is coupled to the drain-to-source voltage V_{DS} of the synchronous rectifier switch Q_{SR} and the input of the reference generator 304. When the synchronous rectifier switch Q_{SR} is on, the drain-to-source voltage V_{DS} is representative of the voltage drop across the on-time resistor R_{ds(ON}). Conversely, when the synchronous rectifier switch Q_{SR} is off, the drain-to-source voltage V_{DS} is representative of the voltage drop across the body diode D_{BODY}. The negative (−) input of the comparator 403 is coupled to the output of the reference generator 404. The output of the comparator 403 is coupled to the input of the off detector 407.

When the synchronous rectifier switch Q_{SR} is operated in the on state by the SR controller 209, the switching element 401 is closed thereby creating a pathway to transfer the energy stored in the transformer T1. When the switching element 401 is closed, current I_R_{ds(ON)} flows through the on-time resistor R_{ds(ON)} to the electronic device causing the drain-to-source voltage drop V_{DS} across the on-time resistor R_{ds(ON}). The on-resistor current I_R_{ds(ON)} is proportional to the secondary current I_{SEC} that is delivered to the electronic load. The magnitude of on-time resistor current I_R_{ds(ON}) decreases as the energy stored in the transformer T1 decreases.

The comparator 403 monitors the drain-to-source voltage V_{DS} with respect to a reference signal 409 generated by the reference generator 405 during each switching cycle of the synchronous rectifier switch Q_{SR}. In one embodiment, the reference signal 409 corresponds to a voltage drop across the synchronous rectifier switch Q_{SR} indicative of an ideal scenario where the secondary current I_{SEC} approaching 0 amps. When the drain-to-source voltage drop V_{DS} is equivalent to the reference signal 409, the comparator 403 outputs a signal 411 that causes the off detector 407 to initiate the SR controller 209 to turn off the synchronous rectifier switch Q_{SR}. Accordingly, the SR controller 209 outputs an output drive signal 211 that operates the synchronous rectifier switch Q_{SR} in the off state. When the synchronous rectifier switch Q_{SR} is in the off state, the switching element 401 opens thereby blocking the pathway for transferring the energy stored in the transformer T1 to the capacitor C1.

In one embodiment, the reference generator 405 also monitors the drain-to-source voltage V_{DS} of the synchronous rectifier switch Q_{SR} during each switching cycle of the synchronous rectifier switch Q_{SR}. The reference generator 405 determines if the reference voltage 409 used to determine whether to turn off the synchronous rectifier switch Q_{SR} during a particular switching cycle resulted in the synchronous rectifier switch Q_{SR} being placed in the off state before substantially all of the energy stored in the transformer T1 was delivered to the output capacitor C1 (i.e., too early) or if the reference voltage 409 resulted in the synchronous rectifier switch Q_{SR} being placed in the off state after a threshold amount of time from when substantially all of the energy stored in the transformer T1 is delivered to the output capacitor C1 (i.e., too late). Based on the monitored voltage drop, the reference generator 405 adjusts the reference voltage 409 used to turn off the synchronous rectifier switch Q_{SR} during subsequent switching cycles thereby adjusting the length of time that the synchronous rectifier switch Q_{SR} is turned on during the subsequent switching cycles.

If the synchronous rectifier switch Q_{SR} is turned off before substantially all of the energy stored in the transformer T1 is delivered to the output capacitor C1, the remaining energy stored in the transformer T1 is delivered to the electronic device via the body diode D_{BODY}. In particular, body diode current I_D_{BODY} starts to flow when the synchronous rectifier switch Q_{SR} is turned off in order to deliver the remaining energy stored in the transformer T1 to the output capacitor C1. As a result, power loss is increased due to the larger voltage drop across the body diode D_{BODY} compared to the voltage drop across the on-time resistor R_{ds(ON}). Conversely, if the synchronous rectifier switch Q_{SR} is turned off after the threshold amount of time from when substantially all of the eenrgy stored in the transformer T1 is delivered to the output capacitor C1, the voltage across the transformer T1 reverses polarity and the secondary current I_{SEC} flows in the negative direction which results in increased noise in the power converter 200.

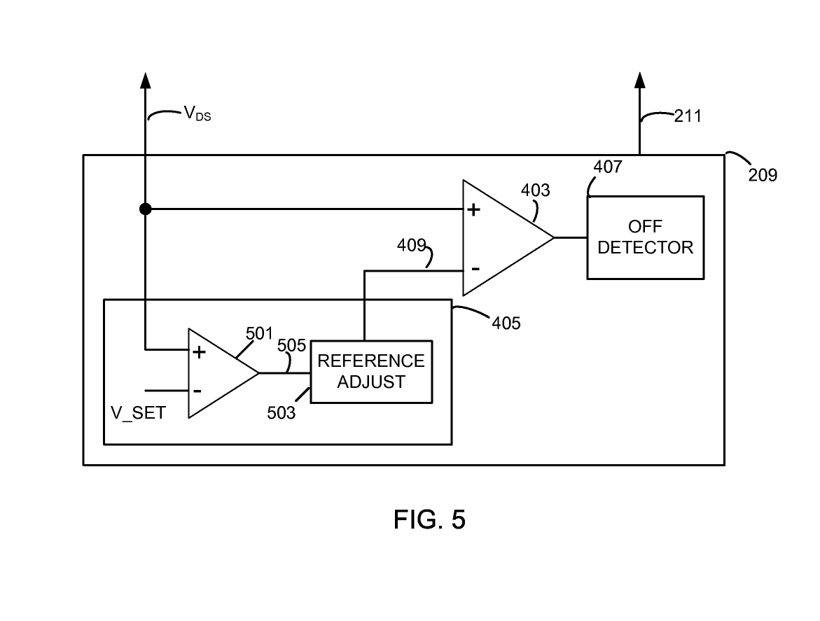

FIG. 5 is a circuit diagram illustrating a detailed view of the reference generator 405 according to one embodiment. The reference generator 405 includes a comparator 501 and a reference adjustment 503. The positive (+) input of the comparator 501 is coupled to the drain-to-source voltage V_{DS} and the negative (−) input of the comparator 501 is coupled to a reference threshold voltage V_SET. In one embodiment, V_SET is the reference voltage for comparator 501 that is used to determine if the body diode D_{BODY} conducts. If reference V_SET is reached, the synchronous rectifier switch Q_{SR} was turned off too early (prior to the secondary current I_{SEC} reaching 0 AMPS) for that switching cycle. The reference voltage 409 is adjusted for the next switching cycle to ensure that the synchronous rectifier switch Q_{SR} is turned off “later” compared to the previous switching cycle. For example, the reference threshold voltage V_SET is 0.1 V. The output of the comparator 501 is coupled to the reference adjust 503 which outputs the reference voltage 409 to the comparator 403.

In one embodiment, the comparator 501 monitors the drain-to-source voltage V_{DS} during each switching cycle. The comparator 501 detects whether the synchronous rectifier switch Q_{SR} is turned off prior to the point where the secondary current reaches 0 Amps, or after the point where the secondary current reaches 0 Amps. If the comparator 401 output 505 goes “LOW” during the switching cycle, it indicates that the synchronous rectifier switch Q_{SR} was turned off too early, allowing for forward conduction through the body diode of synchronous rectifier switch Q_{SR}. Conversely, if the comparator 501 output 505 remains “HIGH” during the switching cycle, it indicates the synchronous rectifier switch Q_{SR} was turned off at the time or after the energy has been delivered to the output capacitor C1.

The reference adjust 503 determines whether the synchronous rectifier switch Q_{SR} is operated in the off state too early or too late based on the output 505 of the comparator 501. If the synchronous rectifier switch Q_{SR} is operated in the off state too early, the reference adjust 503 may increase the reference voltage 409 that will be used to turn off the synchronous rectifier switch Q_{SR} during the next switching cycle of the synchronous rectifier switch Q_{SR}. By increasing the reference voltage 409, the synchronous rectifier switch Q_{SR} is allowed to operate in the on state for a longer period of time thereby providing more time for the stored energy to be transferred to the output capacitor C1. If the synchronous rectifier switch Q_{SR} is operated in the off state after the threshold amount of time from when all the stored power is delivered to the electronic load, reference adjust 503 may decrease (i.e., lower) the reference voltage 409 that will be used to turn off the synchronous rectifier switch Q_{SR} during the next switching cycle of the synchronous rectifier switch Q_{SR}. By decreasing the reference voltage 409, the synchronous rectifier switch Q_{SR} operates in the on state for a shorter period of time thereby providing less time for the stored energy to be transferred to the output capacitor C1.

As mentioned previously, in embodiments where the synchronous rectifier switch Q_{SR} is coupled between the upper side of the secondary winding Ns and the output capacitor C1, the reference adjust 503 may decrease the reference voltage 409 if the synchronous rectifier switch Q_{SR} is operated in the off state too early thereby increasing the amount of time that the synchronous rectifier switch Q_{SR} is allowed to operate in the on state. Conversely, the reference adjust 503 may increase the reference voltage 409 if the synchronous rectifier switch Q_{SR} is operated in the off state too late thereby shortening the amount of time that the synchronous rectifier switch Q_{SR} is allowed to operate in the on state.

In one embodiment, the reference adjust 403 may adjust the reference voltage 409 by a fixed amount (e.g., (+/−) 0.1 mV). Alternatively, the reference adjust 503 employs an algorithm that varies the sign and magnitude of the adjustment of the reference voltage 409.

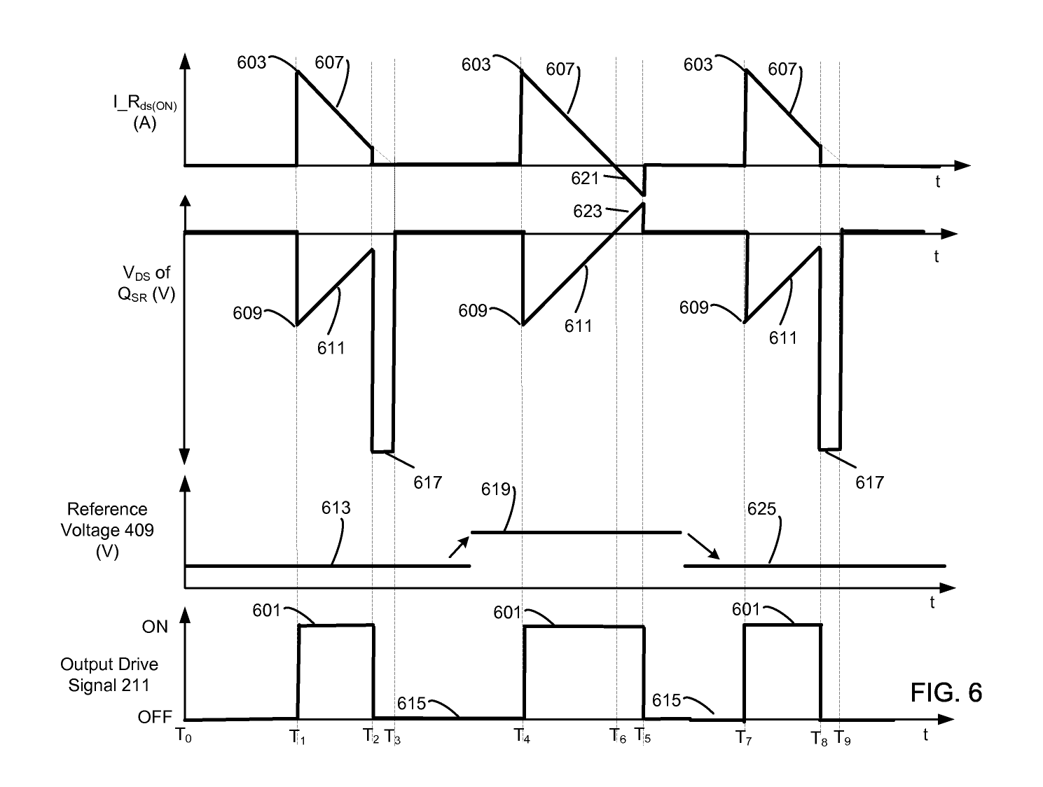

FIG. 6 illustrates waveforms of the power converter 200 describing operation of the synchronous rectifier circuit 209 during a plurality of switching cycles of the power converter 200. In particular, FIG. 6 illustrates waveforms of the power converter 200 across multiple switching cycles when the synchronous rectifier switch Q_{SR} is operated in the off state before all the energy stored in the transformer T1 is delivered to the output capacitor C1 (i.e., too early) and when the synchronous rectifier switch Q_{SR} is operated in the off state after a threshold amount of time from when substantially all the energy stored in the transformer T1 is delivered to the output capacitor C1 (i.e., too late). The waveforms include an output drive signal 211 waveform, a reference voltage 409 waveform, a drain-to-source voltage (V_{DS}) waveform of the synchronous rectifier switch Q_{SR}, and an on-resistor current I_R_{ds(ON}) waveform.

At time T₁, the output drive signal 211 generated by SR controller 209 transitions high 601 thereby turning on the synchronous rectifier switch Q_{SR}. When the synchronous rectifier switch Q_{SR} is turned on at time T₁, the on-resistor current I_R_{ds(ON}) instantaneously reaches a peak 603 on-resistor current I_R_{ds(ON}) and begins to decline 607 as the stored energy in the transformer T₁ is transferred to the output capacitor C1. Similarly, when the synchronous rectifier switch Q_{SR} is turned on at time T₁, the drain-to-source voltage V_{DS} of the synchronous rectifier switch Q_{SR} instantaneously reaches a peak 609 drain-to-source voltage and begins to increase 511 as the energy stored in the transformer T₁ is transferred to the output capacitor C1.

Comparator 403 compares the drain-to-source voltage V_{DS} of the synchronous rectifier switch Q_{SR} with the reference voltage 409 which is at a first level 613 between time T₁ and time T₂. The first level 613 of the reference voltage 409 indicates that the on-resistor current I_R_{ds(ON)} (which is proportional to the secondary current I_{SEC}) is approaching 0 Amps. When the drain-to-source voltage V_{DS} of the synchronous rectifier switch Q_{SR} is equivalent to the reference voltage 409 set by the first level 613, the off detector 407 initiates the SR controller 209 to turn off the synchronous rectifier switch Q_{SR} at time T₂ represented by the output drive signal 211 transitioning low 615. However, as shown in FIG. 6, the on resistor current I_R_{ds(ON)} at time T₂ has not all been delivered to the electronic load. That is, current is still flowing through the on-time resistor R_{ds(ON)}. Thus, the SR controller 209 turned off the synchronous rectifier switch Q_{SR} too early at time T₂. As a result, the remaining current is delivered to the electronic device via the body diode D_{BODY} as shown by the increased drain-to-source voltage V_{DS} 617 of the synchronous rectifier switch Q_{SR} between time T₂ and time T₃.

As a result, the reference generator 405 increases the reference voltage 409 from the first level 613 to a second level 619 for the subsequent switching cycle defined by time T₄ to time T₅. At time T₄, the SR controller 209 outputs a high 601 output drive signal 211 thereby turning on the synchronous rectifier switch Q_{SR}. As mentioned previously, when the synchronous rectifier switch Q_{SR} is turned on, the on resistor current I_R_{ds(ON}) instantaneously reaches a peak 603 on resistor current I_R_{ds(ON}) at time T₄ and the on resistor current I_R_{ds(ON)} begins to decline 607 as the stored energy in the transformer T1 is transferred to the output capacitor C1. Similarly, when the synchronous rectifier switch QsR is turned on at time T₄, the drain-to-source voltage V_{DS} of the synchronous rectifier switch Q_{SR} instantaneously reaches a peak 609 drain-to-source voltage V_{DS} and begins to increase 611 as the stored energy in the transformer T1 is transferred to the output capacitor C1.

Comparator 403 compares the drain-to-source voltage V_{DS} of the synchronous rectifier switch Q_{SR} with the reference voltage 409 which is at a second level 619. When the drain-to-source voltage V_{DS} of the synchronous rectifier switch Q_{SR} is equivalent to the reference voltage 409 set by the second level 619, the off detector 407 initiates the SR controller 209 to turn off the synchronous rectifier switch Q_{SR} at time T₅. However, as shown in FIG. 6, the on resistor current I_R_{ds(ON)} reached substantially zero amps at time T₆ rather than at time T₅ indicating that substantially all the energy stored in the transformer T1 was delivered to the output capacitor at time T₆. Thus, the SR controller 209 turned off the synchronous rectifier switch Q_{SR} too late. As a result, current through the on-time resistor R_{ds(ON)} reverses polarity and energy from output capacitor C1 will be stored in the transformer T1. This energy will be transferred back to V_{DC} after the synchronous rectifier switch Q_{SR} is turned off at the time T₅.

In response to detecting that the synchronous rectifier switch Q_{SR} is turned off after substantially all the energy stored in the transformer T1 is delivered to the output capacitor C1 (i.e., too late), the reference generator 405 lowers the reference voltage 409 from the second level 619 to a third level 625 for the subsequent switching cycle defined by time T₇ to time T₈. Note that the third level 625 is equal to the first level 613. However, in other embodiments, the third level 625 may be lower than the second reference level 619, but greater than the first reference level 613. Thus, the SR controller 209 is hunting for the optimum reference level.

At time T₇, the SR controller 209 outputs a high 601 output drive signal 211 thereby turning on the synchronous rectifier switch Q_{SR}. As mentioned previously, when the synchronous rectifier switch Q_{SR} is turned on, the on resistor current I_R_{ds(ON}) instantaneously reaches a peak 603 on resistor current I_R_{ds(ON}) at time T₇ and begins to decline 607 as the stored energy in the transformer T1 is transferred to the output capacitor C1. Similarly, when the synchronous rectifier switch Q_{SR} is turned on at time T₇, the drain-to-source voltage V_{DS} of the synchronous rectifier switch Q_{SR} instantaneously reaches a peak 609 drain-to-source voltage and begins to increase 611 as the stored energy in the transformer T1 is transferred to the output capacitor C1.

When the drain-to-source voltage V_{DS} of the synchronous rectifier switch Q_{SR} drops to the reference voltage 409 set by the third reference level 625, the OFF detector 407 initiates the SR controller 209 to turn off the synchronous rectifier switch Q_{SR} at time T₈. However, because the third level 625 is substantially equivalent to the first level 613, the SR controller 209 turned off the synchronous rectifier switch Q_{SR} too early at time T₈. As a result, the remaining current is delivered to the output capacitor C1 via the body diode D_{BODY} as shown by the increased drain-to-source voltage V_{DS} 617 of the synchronous rectifier switch Q_{SR} between time T₈ and time T₉. Thus, in one embodiment the SR controller 209 may never identify the optimum reference level and may continually adjust the reference level across the plurality of switching cycles.

However, in embodiments where the third reference level 625 are less than the second reference level 619, but greater than the first reference level 613, the on resistor current I_R_{ds(ON}) may be substantially zero amps when the synchronous rectifier switch Q_{SR} is turned off indicating that the energy stored in the transformer T1 has been delivered to the output capacitor C1 when the synchronous rectifier switch Q_{SR} is turned off. Thus, the SR controller 209 turned off the synchronous rectifier switch Q_{SR} at the optimum time based on the adjusted reference voltage. Thus, in one embodiment, the SR controller 209 continually hunt across a plurality of switching cycles for the reference level that results in turning off the synchronous rectifier switch Q_{SR} at the precise time when substantially all the energy stored in the transformer T1 has been delivered to the output capacitor C1.

Upon reading this disclosure, those of skill in the art will appreciate still additional alternative designs for operating the SR controller to control a synchronous rectifier switch Q_{SR}. Thus, while particular embodiments and applications have been illustrated and described, it is to be understood that the embodiments discussed herein are not limited to the precise construction and components disclosed herein and that various modifications, changes and variations which will be apparent to those skilled in the art may be made in the arrangement, operation and details of the method and apparatus disclosed herein without departing from the spirit and scope of the disclosure.

What is claimed is:

1. A switching power converter comprising:
a magnetic component coupled to an input voltage and an output of the switching power converter;
a switch coupled to the magnetic component, energy stored in the magnetic component when the switch is in an on state;
a first controller configured to generate a first control signal to turn on or turn off the switch at each switching cycle of the switch to maintain regulation of the output of the switching power converter during a discontinuous conduction mode of the switching power converter;
a synchronous rectifier switch coupled to the output of the switching power converter;
a second controller configured to generate a second control signal to turn on or turn off the synchronous rectifier switch at each switching cycle of the synchronous rectifier switch;
wherein the second controller is configured to turn off the synchronous rectifier switch during a first switching cycle of the synchronous rectifier switch based on a comparison of a reference signal and a drain-to-source voltage of the synchronous rectifier switch during the first switching cycle; and
wherein the second controller is configured to determine whether to adjust the reference signal used by the second controller to turn off the synchronous rectifier switch during a second switching cycle subsequent the first switching cycle.

2. The switching power converter of claim 1, wherein the reference signal is representative of an ideal scenario when the synchronous rectifier switch is turned off when current through the synchronous rectifier switch is substantially zero.

3. The switching power converter of claim 2, wherein the second controller is configured to adjust the reference signal based on whether the synchronous rectifier switch is turned off before the current through the synchronous rectifier reached substantially zero or based on whether the synchronous rectifier switch is turned off after the current through the synchronous rectifier switch reached substantially zero.

4. The switching power converter of claim 3, wherein the second controller is configured to determine whether to adjust the reference signal by comparing the drain-to-source voltage during the first switching cycle to a reference threshold, the reference threshold indicating that the current through the synchronous rectifier switch did not reach substantially zero and that current flowed through a body diode of the synchronous rectifier switch.

5. The switching power converter of claim 1, wherein the second controller is further configured to adjust the reference signal over a plurality of switching cycles of the synchronous rectifier switch.

6. The switching power converter of claim 1, wherein the second controller is configured to adjust the reference signal by a predetermined amount.

7. The switching power converter of claim 1, wherein the second controller is configured to adjust the reference signal using an algorithm that varies a sign and magnitude of the reference signal.

8. The switching power converter of claim 1, wherein the second controller is further configured to turn off the synchronous rectifier switch during the second switching cycle of the synchronous rectifier switch based on the adjusted magnitude of the reference signal, and wherein the second controller is further configured to determine whether to further adjust the adjusted magnitude of the reference signal used by the second controller to turn off the synchronous rectifier switch during a third switching cycle subsequent the second switching cycle.

9. The switching power converter of claim 1, wherein the second controller is configured to adjust the reference signal to delay the turn off of the synchronous rectifier switch during the second switching cycle responsive to detecting forward current through a body diode during the first switching cycle.

10. The switching power converter of claim 1, wherein the second controller is configured to adjust the reference signal to advance the turn off of the synchronous rectifier switch during the second switching cycle responsive to detecting a lack of forward current through a body diode during the first switching cycle.

11. In a second controller, a method of controlling a switching power converter, the switching power converter including a magnetic component coupled to an input voltage and an output of the switching power converter, a switch coupled to the magnetic component, energy stored in the magnetic component when the switch is in an on state, the switching power converter further including a first controller configured to generate a first control signal to turn on or turn off the switch at each switching cycle of the switch to maintain regulation of the output of the switching power converter during a discontinuous conduction mode of the switching power converter, a synchronous rectifier switch coupled to the output of the switching power converter, the switching power converter further including the second controller, the method comprising:
turning off the synchronous rectifier switch during a first switching cycle of the synchronous rectifier switch based on a comparison of a reference signal and a drain-to-source voltage of the synchronous rectifier switch during the first switching cycle; and
determining whether to adjust the reference signal used by the second controller to turn off the synchronous rectifier switch during a second switching cycle subsequent the first switching cycle.

12. The method of claim 11, wherein the reference signal is representative of an ideal scenario when the synchronous rectifier switch is turned off when current through the synchronous rectifier switch is substantially zero.

13. The method of claim 12, further comprising:
adjusting the reference signal based on whether the synchronous rectifier switch is turned off before the current through the synchronous rectifier reached substantially zero or based on whether the synchronous rectifier switch is turned off after the current through the synchronous rectifier switch reached substantially zero.

14. The method of claim 13, wherein determining whether to adjust the reference signal comprises:
comparing the drain-to-source voltage during the first switching cycle to a reference threshold, the reference threshold indicating that current through the synchronous rectifier switch did not reach substantially zero and that current flowed through a body diode of the synchronous rectifier switch.

15. The method of claim 11, further comprising:
adjusting the reference signal over a plurality of switching cycles of the synchronous rectifier switch.

16. The method of claim 11, further comprising:
adjusting the reference signal by a predetermined amount.

17. The method of claim 11, further comprising:
adjusting the reference signal using an algorithm that varies a sign and magnitude of the reference signal.

18. The method of claim 11, further comprising:
turning off the synchronous rectifier switch during the second switching cycle of the synchronous rectifier switch based on the adjusted magnitude of the reference signal;
determining whether to further adjust the adjusted magnitude of the reference signal used by the second controller to turn off the synchronous rectifier switch during a third switching cycle subsequent the second switching cycle.

19. The method of claim 11, wherein adjusting the reference signal delays the turn off of the synchronous rectifier switch during the second switching cycle responsive to detecting forward current through a body diode during the first switching cycle.

20. The method of claim 11, wherein adjusting the reference signal advances the turn off of the synchronous rectifier switch is during the second switching cycle responsive to detecting a lack of forward current through a body diode during the first switching cycle.
